(19) United States
(12) Patent Application Publication
(10) Pub. No.: US 2024/0176168 A1
(43) Pub. Date: May 30, 2024

(54) OPTICAL DEVICE, OPTICAL TRANSMISSION APPARATUS, AND OPTICAL RECEPTION APPARATUS

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/244,071

(22) Filed: Sep. 8, 2023

(30) Foreign Application Priority Data
Nov. 25, 2022 (JP) 2022-188480

(51) Int. Cl. G02F 1/01

(52) U.S. Cl. CPC G02F 1/0147; G02F 1/0113; G02F 1/0121; G02F 2201/12; G02F 2203/50

(57) ABSTRACT

An optical device includes a heater electrode that heats an optical waveguide, an electrode that has larger conductivity than conductivity of the heater electrode, and a via that electrically connects the heater electrode and the electrode. The heater electrode includes a connection portion that is connected to the via and that has a large electrode width, and a main body that has a thinner electrode width than the electrode width of the connection portion. The via is located on a center line of the heater electrode and includes a via end portion at a side of the main body, where the via end portion is configured to diffuse electric current that flows between the via and the heater electrode.

### CROSS-REFERENCE TO RELATED APPLICATION

This application is based upon and claims the benefit of priority of the prior Japanese Patent Application No. 2022-188480, filed on Nov. 25, 2022, the entire contents of which are incorporated herein by reference.

### FIELD

The embodiments discussed herein are related to an optical device, an optical transmission apparatus, and an optical reception apparatus.

### BACKGROUND

An optical modulator in an optical transmission apparatus and an optical receiver in an optical reception apparatus that are used for high-speed optical communication include built-in phase shifters. A phase shifter increases temperature inside an optical waveguide with the aid of heater heat, so that a refractive index inside the optical waveguide is changed due to the increase in the temperature and a phase of signal light that passes through the inside of the optical waveguide is shifted in accordance with the change of the refractive index.

FIG. 20 is a schematic plan view illustrating one example of a conventional phase shifter 100, and FIG. 21 is a schematic cross-sectional view taken along a line A-A illustrated in FIG. 20. The phase shifter 100 illustrated in FIG. 20 includes an Si substrate 111, a cladding layer 112, an optical waveguide 101, a heater electrode 102, electrodes 103, and vias 104. The cladding layer 112 is laminated on the Si substrate 111 and surrounds the optical waveguide 101 that is arranged above the Si substrate 111 and surrounds the heater electrode 102 that is arranged above the optical waveguide 101.

The cladding layer 112 is a dielectric that is made of a material with a lower refractive index, such as SiO₂ (silicon dioxide), than Si (silicon) of the optical waveguide 101, for example. The optical waveguide 101 is a waveguide, such as a channel waveguide, which is made of, for example, Si, and through which signal light passes. The heater electrode 102 is made of, for example, resistive metal, such as TiN (titanium nitride) or Ti (titanium), generates heater heat in accordance with driving current, and increases temperature inside the optical waveguide 101. The electrodes 103 include an input-side electrode that inputs electric current to the heater electrode 102 by application of voltage, and an output-side electrode that outputs electrical current from the heater electrode 102. The electrodes 103 are made of metal with a low resistance value, such as Al (aluminum) or Cu (copper), for example. The vias 104 electrically connects the heater electrode 102 and the electrodes 103. The vias 104 are made of metal, such as tungsten, for example. Conductivity of the heater electrode 102 is reduced as compared to conductivity of the vias 104.

In the phase shifter 100, if voltage is applied to the electrodes 103, electric current flows through the heater electrode 102, so that heater heat is generated and temperature of the optical waveguide 101 is increased by the heater heat. If the temperature of the optical waveguide 101 is increased, a refractive index inside the optical waveguide 101 is changed due to a thermo-optic effect of Si that constitutes the optical waveguide 101. Further, the phase shifter 100 shifts a phase of signal light that passes through the inside of the optical waveguide 101 in accordance with a change of the refractive index inside the optical waveguide 101.

However, in the conventional phase shifter 100, an electrode width of the heater electrode 102 is larger than a width of the optical waveguide 101; therefore, the heater heat that is generated by the heater electrode 102 is diffused to a portion other than the optical waveguide 101, so that heating efficiency of the optical waveguide 101 is reduced and power consumption is increased. Therefore, to cope with the situation as described above, a phase shifter 100A in which the electrode width of the heater electrode 102 is reduced has been proposed.

FIG. 22 is a schematic plan view illustrating one example of the conventional phase shifter 100A, and FIG. 23 is a schematic cross-sectional view taken along a line A-A illustrated in FIG. 22. Meanwhile, the same components as those of the phase shifter 100 illustrated in FIG. 20 are denoted by the same reference symbols, and explanation of the same components and the same operation will be omitted. The phase shifter 100A illustrated in FIG. 22 is different from the phase shifter 100 illustrated in FIG. 20 in that an electrode width of a heater electrode 102A is reduced.

The phase shifter 100A is configured such that the electrode width of the heater electrode 102A is reduced, so that it is possible to locally heat a portion of the optical waveguide 101 by the heater heat that is generated by the heater electrode 102A. As a result, it is possible to reduce power consumption of the phase shifter 100A.

FIG. 24 is a diagram for explaining one example of a voltage change with respect to the heater electrode 102A of the conventional phase shifter 100A. Meanwhile, for convenience of explanation, it is assumed that electric current flows from the electrode 103 on the left side in the drawing to the electrode 103 on the right side in the drawing via the heater electrode 102A, for example. Conductivity of the heater electrode 102A is smaller than the conductivity of the vias 104, so that voltage of the heater electrode 102A that comes into contact with the left-side via 104 and the right-side via 104 is stable. However, a voltage drop starts from the heater electrode 102A that is located at a portion of a corner 104A of the via 104 that is a portion in which electric current is concentrated, and the voltage gradually decreases until a portion of the corner 104A of the via 104 at which the right-side via 104 and the heater electrode 102A come into contact with each other.
Patent Literature 1: U.S. Patent Application Publication No. 2018/0100966
Patent Literature 2: Japanese Laid-open Patent Publication No. 2019-12120
Patent Literature 3: U.S. Patent Application Publication No. 2016/0377953
Patent Literature 4: International Publication Pamphlet No. WO2011/065384

In the conventional phase shifter 100A, the electric current flows from the via 104 that has a wide width to the heater electrode 102A that is elongated in a plan view. However, the conductivity of the heater electrode 102A is smaller than the conductivity of the via 104, so that the electric current is concentrated in the portion of the corner 104A of the via 104 in which the heater electrode 102A and the via 104 are located closest to each other. As a result, the portion in which the electric current is concentrated is locally heated and the local heating adversely affects the heater electrode 102A, so that long-term reliability of the heater electrode 102A may be affected.

### SUMMARY

According to an aspect of an embodiment, an optical device includes a heater electrode, an electrode and a via. The heater electrode heats an optical waveguide. The electrode has larger conductivity than conductivity of the heater electrode. The via electrically connects the heater electrode and the electrode. The heater electrode includes a connection portion and a main body. The connection portion is connected to the via and has a large electrode width. The main body has a thinner electrode width than the electrode width of the connection portion. The via is located on a center line of the heater electrode and includes a via end portion at a side of the main body. The via end portion is configured to diffuse electric current that flows between the via and the heater electrode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view illustrating one example of a phase shifter of a first embodiment;

FIG. 2A is a schematic cross-sectional view taken along a line A-A illustrated in FIG. 1;

FIG. 2B is a schematic cross-sectional view taken along a line B-B illustrated in FIG. 1;

FIG. 3 is a diagram for explaining one example of a voltage change with respect to a heater electrode of the phase shifter of the first embodiment;

FIG. 4 is a schematic plan view illustrating one example of a phase shifter of a second embodiment;

FIG. 5A is a schematic cross-sectional view taken along a line A-A illustrated in FIG. 4;

FIG. 5B is a schematic cross-sectional view taken along a line B-B illustrated in FIG. 4;

FIG. 6 is a diagram for explaining one example of a voltage change with respect to a heater electrode of the phase shifter of the second embodiment;

FIG. 7 is a schematic plan view illustrating one example of a phase shifter of a third embodiment;

FIG. 8A is a schematic cross-sectional view taken along a line A-A illustrated in FIG. 7;

FIG. 8B is a schematic cross-sectional view taken along a line B-B illustrated in FIG. 7;

FIG. 9 is a diagram for explaining one example of a voltage change with respect to a heater electrode of the phase shifter of the third embodiment;

FIG. 10 is a schematic plan view illustrating one example of a phase shifter of a fourth embodiment;

FIG. 11 is a schematic cross-sectional view taken along a line A-A illustrated in FIG. 10;

FIG. 12 is a diagram for explaining one example of a voltage change with respect to a heater electrode of the phase shifter of the fourth embodiment;

FIG. 13 is a schematic plan view illustrating one example of a phase shifter of the fifth embodiment;

FIG. 14A is a schematic cross-sectional view taken along a line A-A illustrated in FIG. 13;

FIG. 14B is a schematic cross-sectional view taken along a line B-B illustrated in FIG. 13;

FIG. 15 is a diagram for explaining one example of a voltage change with respect to a heater electrode of the phase shifter of the fifth embodiment;

FIG. 16 is a schematic plan view illustrating one example of a phase shifter of a sixth embodiment;

FIG. 17A is a schematic cross-sectional view taken along a line A-A illustrated in FIG. 16;

FIG. 17B is a schematic cross-sectional view taken along a line B-B illustrated in FIG. 16;

FIG. 18 is a diagram for explaining one example of a voltage change with respect to a heater electrode of the phase shifter of the sixth embodiment;

FIG. 19 is a diagram for explaining one example of an optical communication apparatus of one embodiment;

FIG. 20 is a schematic plan view illustrating one example of a conventional phase shifter;

FIG. 21 is a schematic cross-sectional view taken along a line A-A illustrated in FIG. 20;

FIG. 22 is a schematic plan view illustrating one example of the conventional phase shifter;

FIG. 23 is a schematic cross-sectional view taken along a line A-A illustrated in FIG. 22; and

FIG. 24 is a diagram for explaining one example of a voltage change with respect to a heater electrode of the conventional phase shifter.

### DESCRIPTION OF EMBODIMENTS

Embodiments of an optical device or the like disclosed in the present application will be described in detail below with reference to the drawings. The present invention is not limited by the embodiments below. In addition, the embodiments described below may be combined appropriately as long as no contradiction is derived.

### (a) First Embodiment

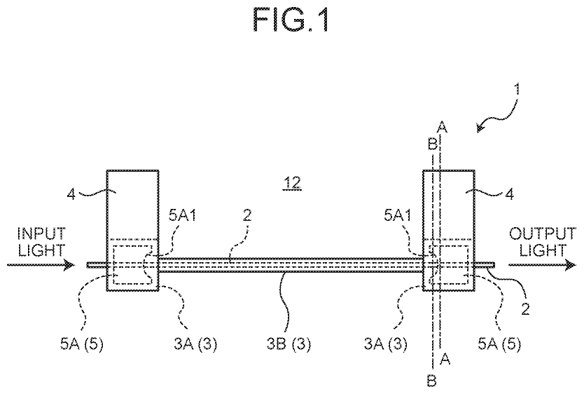

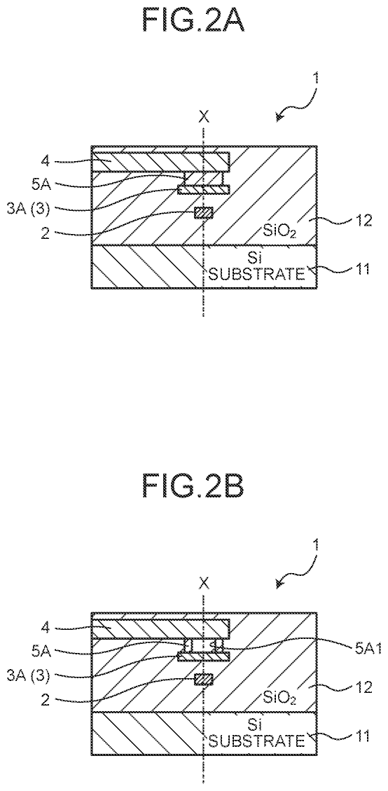

FIG. 1 is a schematic plan view illustrating one example of a phase shifter 1 of a first embodiment, FIG. 2A is a schematic cross-sectional view taken along a line A-A illustrated in FIG. 1, and FIG. 2B is a schematic cross-sectional view taken along a line B-B illustrated in FIG. 1. The phase shifter 1 illustrated in FIG. 1 includes an Si substrate 11, a cladding layer 12, an optical waveguide 2, a heater electrode 3, electrodes 4, and vias 5. The cladding layer 12 is laminated on the Si substrate 11 and surrounds the optical waveguide 2 that is arranged above the Si substrate 11 and surrounds the heater electrode 3 that is arranged on or in the vicinity of the optical waveguide 2.

The cladding layer 12 is a dielectric that is made of a material with a lower refractive index, such as SiO₂ (silicon dioxide), than Si (silicon) of the optical waveguide 2, for example. The optical waveguide 2 is a waveguide, such as a channel waveguide, which is made of, for example, Si, and through which signal light passes. The heater electrode 3 is made of, for example, resistive metal, such as TiN (titanium nitride) or Ti (titanium), generates heater heat in accordance with driving current, and increases temperature inside the optical waveguide 2. The electrodes 4 include an input-side electrode that inputs electric current to the heater electrode 3 by application of voltage, and an output-side electrode that outputs electrical current from the heater electrode 3. The electrodes 4 are made of metal with a low resistance value, such as Al (aluminum) or Cu (copper), for example. The vias 5 electrically connect the heater electrode 3 and the electrodes 4. The vias 5 are made of metal, such as tungsten, for example. Conductivity of the heater electrode 3 is reduced as compared to conductivity of the vias 5. Conductivity of the electrodes 4 is increased as compared to the conductivity of the heater electrode 3.

In the phase shifter 1, if voltage is applied to the electrodes 4, electric current flows through the heater electrodes 3, so that heater heat is generated and temperature of the optical waveguide 2 is increased by the heater heat. If the temperature of the optical waveguide 2 is increased, a refractive index inside the optical waveguide 2 is changed due to a thermo-optic effect of Si that constitutes the optical waveguide 2. Further, the phase shifter 1 shifts a phase of signal light that passes through the inside of the optical waveguide 2 in accordance with the change of the refractive index inside the optical waveguide 2.

The heater electrode 3 includes connection portions 3A that have wide electrode widths and that are located at connection portions connected to the vias 5, and a main body 3B that connects the connection portions 3A on both sides and that has an elongated electrode width.

The vias 5 are vias 5A that have approximately rectangular planar shapes as illustrated in FIG. 1. A center line X of the heater electrode 3 corresponds to a position of the optical waveguide 2, and the via 5A illustrated in FIG. 2A and FIG. 2B is located just above the optical waveguide 2. Further, the via 5A is located on the center line X of the heater electrode 3. Via end portions at the sides of the main body 3B include recessed portions 5A1 that are configured such that electric current flowing between the vias 5A and the heater electrode 3 is diffused and that have mortar shapes as recessed planar shapes. The recessed portions 5A1 are located on the center line X of the heater electrode 3, and the widths of the vias 5A are increased as compared to the electrode width of the main body 3B of the heater electrode 3; therefore, the main body 3B that is a thin portion of the heater electrode 3 and the vias 5A are separated, so that electric current that flows from the vias 5A to the main body 3B that is a thin portion of the heater electrode 3 is diffused. As a result, the electric current is diffused from the center line X and it is possible to prevent a situation in which the electric current is concentrated at boundaries between the vias 5A and the heater electrode 3.

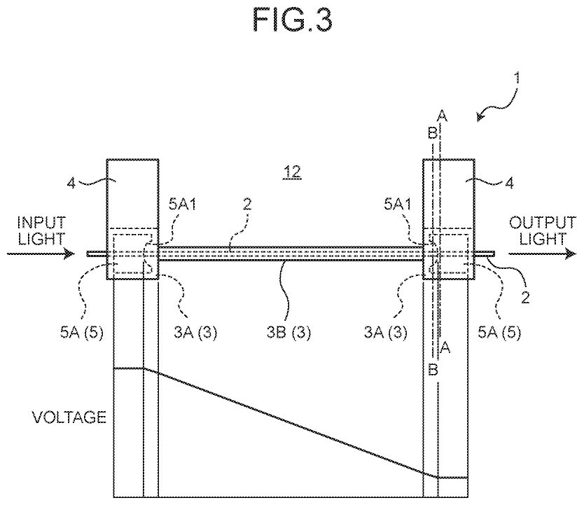

FIG. 3 is a diagram for explaining one example of a voltage change with respect to the heater electrode 3 of the phase shifter 1 of the first embodiment. Meanwhile, for convenience of explanation, it is assumed that electric current flows from the electrode 4 on the left side in the drawing to the electrode 4 on the right side in the drawing via the heater electrode 3. The conductivity of the heater electrode 3 is smaller than the conductivity of the vias 5A, so that voltage of the heater electrode 3 that comes into contact with the left-side via 5A and the right-side via 5A is stable. A voltage drop starts from the connection portion 3A of the heater electrode 3 that is located in the recessed portion 5A1 of the left-side via 5A, but a change of the voltage drop is slow. Further, the voltage gradually decreases from the main body 3B of the heater electrode 3 to the connection portion 3A that is located in the recessed portion 5A1 of the right-side via 5A. Furthermore, a change of the voltage drop slows down from the connection portion 3A of the heater electrode 3 that is located in the recessed portion 5A1 of the right-side via 5A, and then the voltage drop is stopped.

In other words, in the connection portion 3A of the heater electrode 3 that is located in the recessed portion 5A1 of the left-side via 5A (the right-side via 5A), a change of the voltage drop slows down, so that it is possible to prevent a situation in which electric current is concentrated at the boundary between the via 5A and the heater electrode 3.

The phase shifter 1 of the first embodiment is configured such that the electrode width of the heater electrode 3 is increased in the connection portions 3A that come into contact with the vias 5A, the vias 5A are located on the center line X of the heater electrode 3, and the via end portions at the sides of the main body 3B that is a thin portion of the heater electrode 3 are formed as the recessed portions 5A1 that have the mortar planar shapes. As a result, the main body 3B in which the electrode width of the heater electrode 3 is reduced and the vias 5A are partly separated from each other and flowing electric current is diffused, so that it is possible to prevent a situation in which the electric current is concentrated at the boundaries between the vias 5A and the heater electrode 3. Further, it is possible to ensure the long-term reliability of the heater electrode 3 while reducing power consumption.

Meanwhile, for convenience of explanation, the phase shifter 1 is illustrated as an example of the optical device of the present invention, but the technology is not limited to the phase shifter 1 and may be applied to, for example, a direct-current (DC) modulator or a variable optical attenuator (VOA).

Further, while the example has been described in which the vias 5A are made of tungsten and the electrodes 4 are made of Al, Cu, or the like, the vias 5A may be made of the same material as the electrodes 4. As a result, if the vias 5A are made of the same material as the electrodes 4, it is possible to improve manufacturing performance.

Furthermore, while the example has been described in which the center line X of the heater electrode 3 corresponds to the position of the optical waveguide 2, embodiments are not limited to this example, and, for example, it may be possible to provide an offset between the center line X of the heater electrode 3 and the position of the optical waveguide 2.

Meanwhile, resistivity of the heater electrode 3 of the first embodiment is large, so that, in some cases, electric current may be concentrated in the corner portions of the main body 3B in which the electrode width of the heater electrode 3 is reduced as compared to the connection portions 3A that have the wide widths. Therefore, an embodiment that copes with the situation as described above will be described below as a second embodiment.

### (b) Second Embodiment

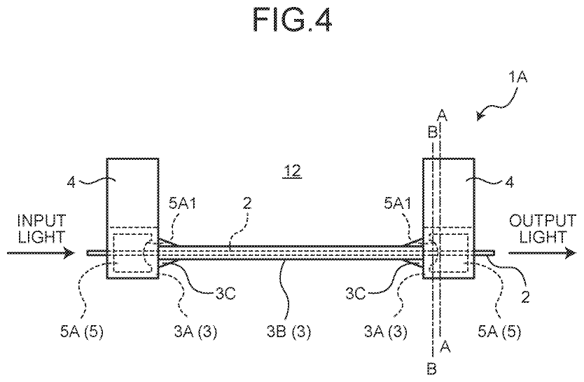

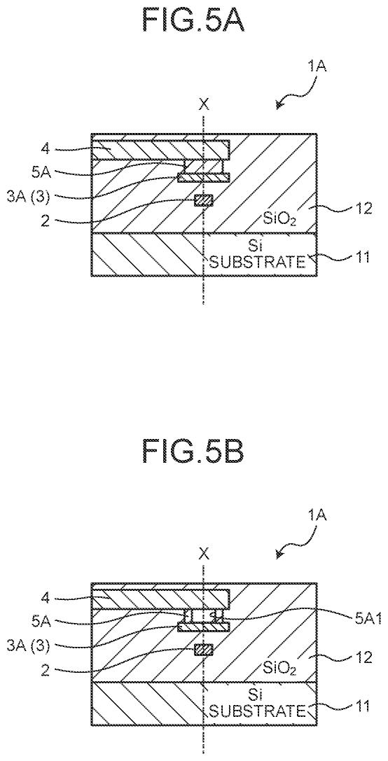

FIG. 4 is a schematic plan view illustrating one example of a phase shifter 1A of the second embodiment, FIG. 5A is a schematic cross-sectional view taken along a line A-A illustrated in FIG. 4, and FIG. 5B is a schematic cross-sectional view taken along a line B-B illustrated in FIG. 4. Meanwhile, the same components as those of the phase shifter 1 of the first embodiment are denoted by the same reference symbols, and explanation of the same components and the same operation will be omitted.

The phase shifter 1A of the second embodiment is different from the phase shifter 1 of the first embodiment in that the heater electrode 3 includes tapered portions 3C in which the electrode widths are gradually reduced from the connection portions 3A toward the main body 3B.

The heater electrode 3 includes the connection portions 3A that are connected to the electrodes 4 and that have wide electrode widths, the main body 3B that is connected to the connection portions 3A and that has an elongated electrode width, and the tapered portions 3C that are formed between the connection portions 3A and the main body 3B and that have electrode widths that are gradually reduced from the connection portions 3A to the main body 3B. The tapered portions 3C are configured such that the electrode widths are gradually reduced from the connection portions 3A to the main body 3B, so that flow of electric current is moderately changed and it becomes possible to prevent the electric current from being locally concentrated in corners between the connection portions 3A and the main body 3B.

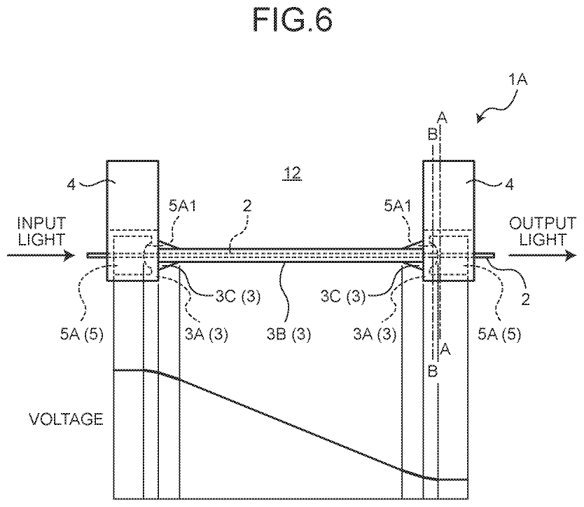

FIG. 6 is a diagram for explaining one example of a voltage change with respect to the heater electrode 3 of the phase shifter 1A of the second embodiment. Meanwhile, for convenience of explanation, it is assumed that electric current flows from the electrode 4 on the left side in the drawing to the electrode 4 on the right side in the drawing via the heater electrode 3. The conductivity of the heater electrode 3 is smaller than the conductivity of the vias 5A, so that voltage of the heater electrode 3 that comes into contact with the left-side via 5A and the right-side via 5A is stable. A voltage drop starts from the connection portion 3A of the heater electrode 3 that is located in the recessed portion 5A1 of the left-side via 5A, but a change of the voltage drop is slow. Further, a change of the voltage drop slows down in the left-side tapered portion 3C from the left-side connection portion 3A to the main body 3B. Furthermore, the voltage gradually decreases from the main body 3B of the heater electrode 3 to the connection portion 3A that is located in the recessed portion 5A1 of the right-side via 5A. Moreover, a change of the voltage drop slows down in the right-side tapered portion 3C from the main body 3B to the right-side connection portion 3A. Furthermore, a change of the voltage drop slows down from the connection portion 3A of the heater electrode 3 that is located in the recessed portion 5A1 of the right-side via 5A, and then the voltage drop is stopped.

In other words, in the connection portion 3A of the heater electrode 3 that is located in the recessed portion 5A1 of the left-side via 5A (the right-side via 5A), a change of the voltage drop slows down, so that it is possible to prevent a situation in which electric current is concentrated at the boundary between the via 5A and the heater electrode 3. Further, a change of the voltage drop in the left-side tapered portion 3C from the left-side connection portion 3A to the main body 3B and a change of the voltage drop in the right-side tapered portion 3C from the main body 3B to the right-side connection portion 3A slow down, so that it is possible to prevent electric current from being concentrated between the connection portions 3A and the main body 3B in the heater electrode 3.

In the phase shifter 1A of the second embodiment, the tapered portions 3C in which the electrode widths are gradually reduced from the connection portions 3A to the main body 3B are arranged between the connection portions 3A and the main body 3B in the heater electrode 3. As a result, electric current moderately flows in the tapered portions 3C between the connection portions 3A and the main body 3B, so that it is possible to prevent the electric current from being concentrated between the connection portions 3A and the main body 3B in the heater electrode 3.

Meanwhile, in the phase shifter 1A of the second embodiment, the example has been described in which the end portions of the vias 5A are formed as the recessed portions 5A1 that have the mortar planar shapes, but embodiments are not limited to this example and an appropriate change is applicable; therefore, another embodiment will be described below as a third embodiment.

### (c) Third Embodiment

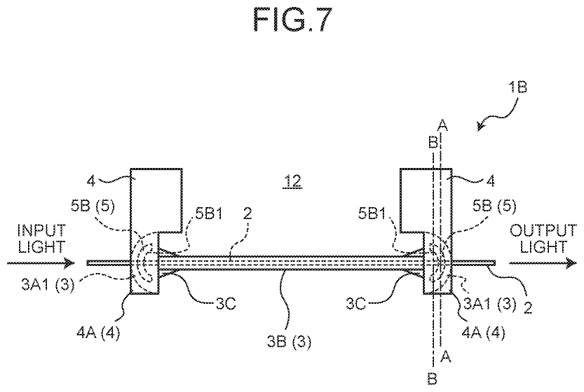

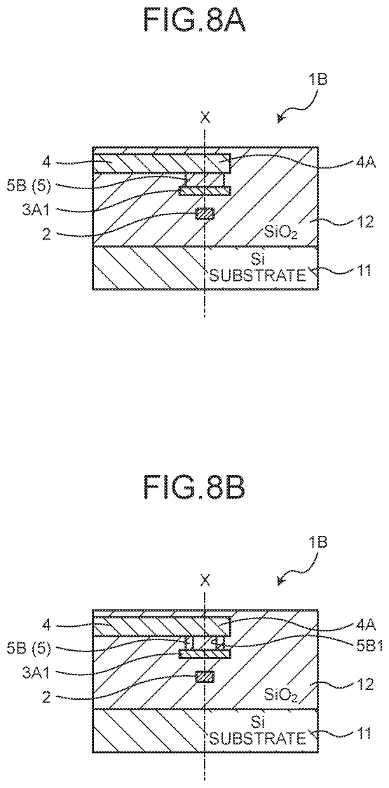

FIG. 7 is a schematic plan view illustrating one example of a phase shifter 1B of the third embodiment, FIG. 8A is a schematic cross-sectional view taken along a line A-A illustrated in FIG. 7, and FIG. 8B is a schematic cross-sectional view taken along a line B-B illustrated in FIG. 7. Meanwhile, the same components as those of the phase shifter 1A of the second embodiment will be denoted by the same reference symbols, and explanation of the same components and the same operation will be omitted.

The phase shifter 1B of the third embodiment is different from the phase shifter 1A of the second embodiment in that arc-shaped vias 5B are provided instead of the vias 5A that have approximately rectangular planar shapes. Further, the arc-shaped vias 5B are thinner than the electrode widths of the electrodes 4. Portions 4A of the electrodes 4 that come into contact with the arc-shaped vias 5B are thinned similarly to the widths of the arc-shaped vias 5B. Connection portions 3A1 of the heater electrode 3 that come into contact with the arc-shaped vias 5B are also thinned similarly to the widths of the arc-shaped via 5B. As a result, it is possible to reduce sizes of the arc-shaped vias 5B as compared to the rectangular vias 5A of the second embodiment.

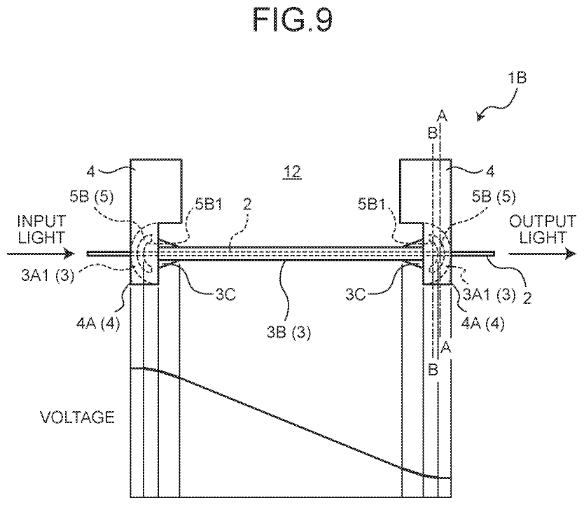

FIG. 9 is a diagram for explaining one example of a voltage change with respect to the heater electrode 3 of the phase shifter 1B of the third embodiment. Meanwhile, for convenience of explanation, it is assumed that electric current flows from the electrode 4 on the left side in the drawing to the electrode 4 on the right side in the drawing via the heater electrode 3. The conductivity of the heater electrode 3 is smaller than conductivity of the vias 5B, so that voltage of the heater electrode 3 that comes into contact with the left-side arc-shaped via 5B and the right-side arc-shaped via 5B is stable. A voltage drop starts from the connection portion 3A of the heater electrode 31 that is located in a recessed portion 5B1 of the left-side arc-shaped via 5B, but a change of the voltage drop is slow. Further, a change of the voltage drop slows down in the left-side tapered portion 3C from the left-side connection portion 3A1 to the main body 3B. Furthermore, the voltage gradually decreases from the main body 3B of the heater electrode 3 to the connection portion 3A1 that is located in the recessed portion 5B1 of the right-side arc-shaped via 5B. Moreover, a change of the voltage drop slows down in the right-side tapered portion 3C from the main body 3B to the right-side connection portion 3A1. Furthermore, a change of the voltage drop slows down from the connection portion 3A of the heater electrode 31 that is located in the recessed portion 5B1 of the right-side arc-shaped via 5B, and then the voltage drop is stopped.

In other words, in the connection portion 3A of the heater electrode 31 that is located in the recessed portion 5B1 of the left-side via 5B (the right-side via 5B), a change of the voltage drop slows down, so that it is possible to prevent a situation in which electric current is concentrated at the boundary between the arc-shaped via 5B and the heater electrode 3. A change of the voltage drop in the left-side tapered portion 3C from the left-side connection portion 3A1 to the main body 3B and a change of the voltage drop in the right-side tapered portion 3C from the main body 3B to the right-side connection portion 3A1 slow down, so that it is possible to prevent electric current from being concentrated between the connection portions 3A1 and the main body 3B in the heater electrode 3.

In the phase shifter 1B of the third embodiment, the electrodes 4 and the heater electrode 3 are connected to each other by the arc-shaped vias 5B. In the phase shifter 1B, it is possible to reduce the sizes of the arc-shaped vias 5B, and it is also possible to reduce sizes of the portions 4A of the electrodes 4 that come into contact with the arc-shaped vias 5B and sizes of the connection portions 3A1 of the heater electrode 3 that come into contact with the arc-shaped vias 5B. As a result, it is possible to reduce a size of the phase shifter 1B. Furthermore, the sizes of the arc-shaped vias 5B are reduced and the electrode widths of the heater electrode 3 and the electrode 4 are reduced, so that it is possible to reduce heat conduction from the heater electrode 3 in which temperature increases to the electrodes 4.

Meanwhile, in the phase shifter 1B of the third embodiment, the example has been described in which the electrodes 4 and the connection portions 3A1 of the heater electrode 3 are connected to each other by the arc-shaped vias 5B, but the shapes are not limited to the arc shapes and an appropriate change is applicable; therefore, another embodiment will be described below as a fourth embodiment.

### (d) Fourth Embodiment

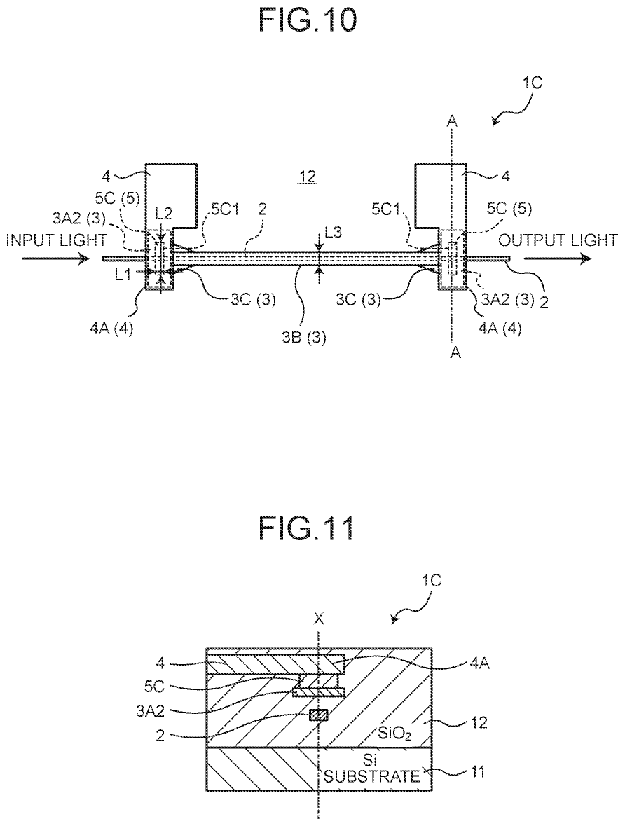

FIG. 10 is a schematic plan view illustrating one example of a phase shifter 1C of the fourth embodiment, and FIG. 11 is a schematic cross-sectional view taken along a line A-A illustrated in FIG. 10. Meanwhile, the same components as those of the phase shifter 1B of the third embodiment will be denoted by the same reference symbols, and explanation of the same components and the same operation will be omitted.

The phase shifter 1C of the fourth embodiment is different from the phase shifter 1B of the third embodiment in that the phase shifter 1C includes rectangular vias 5C instead of the arc-shaped vias 5B. The rectangular vias 5C are thinned as compared to the electrode widths of the electrodes 4. The portions 4A of the electrodes 4 that are connected to the rectangular vias 5C are thinned similarly to the widths of the rectangular vias 5C. Connection portions 3A2 of the heater electrode 3 that are connected to the rectangular vias 5C are also thinned similarly to the width of the rectangular via 5C. As a result, it is possible to reduce sizes of the rectangular vias 5C as compared to the vias 5A of the second embodiment.

The widths of the rectangular vias 5C are thick as compared to the electrode width of the main body 3B of the heater electrode 3. Via end portions of the rectangular vias 5C at the sides of the main body 3B of the heater electrode 3 are formed as linear portions 5C1 that have linear planar shapes.

The rectangular vias 5C are rectangular vias that include first sides L1 parallel to the optical waveguide 2 and second sides L2 perpendicular to the optical waveguide 2, where first dimensions of the first sides L1 are shorter than second dimensions of the second sides L2. Further, the first dimensions of the rectangular vias 5C are longer than a width dimension L3 of the main body 3B of the heater electrode 3.

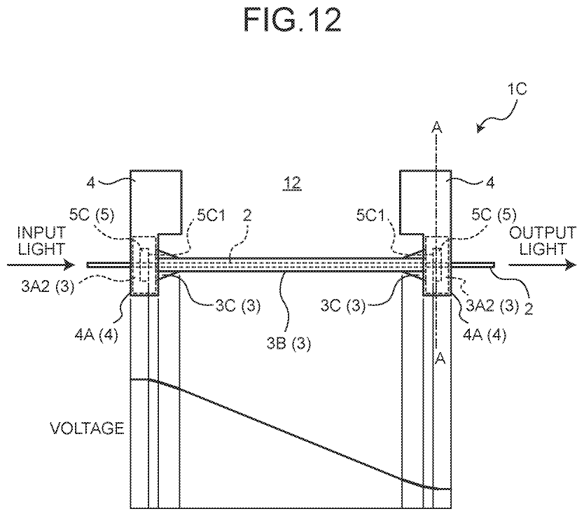

FIG. 12 is a diagram for explaining one example of a voltage change with respect to the heater electrode 3 of the phase shifter 1C of the fourth embodiment. Meanwhile, for convenience of explanation, it is assumed that electric current flows from the electrode 4 on the left side in the drawing to the electrode 4 on the right side in the drawing via the heater electrode 3. The conductivity of the heater electrode 3 is smaller than conductivity of the vias 5C, so that voltage of the heater electrode 3 that comes into contact with the left-side via 5C and the right-side via 5C is stable. Furthermore, a voltage drop starts from the connection portion 3A of the heater electrode 32 that is located in the linear portion 5C1 of the left-side via 5C, but a change of the voltage drop is slow. A change of the voltage drop slows down in the left-side tapered portion 3C from the left-side connection portion 3A2 to the main body 3B. Furthermore, the voltage gradually decreases from the main body 3B of the heater electrode 3 to the connection portion 3A2 that is located in the linear portion 5C1 of the right-side via 5C. Moreover, a change of the voltage drop slows down in the right-side tapered portion 3C from the main body 3B to the right-side connection portion 3A2. Furthermore, a change of the voltage drop slows down from the connection portion 3A of the heater electrode 32 that is located in the linear portion 5C1 of the right-side via 5C, and then the voltage drop is stopped.

In other words, in the connection portion 3A2 of the heater electrode 3 that is located in the linear portion 5C1 of the left-side via 5C (the right-side via 5C), a change of the voltage drop slows down, so that it is possible to prevent a situation in which electric current is concentrated at the boundary between the rectangular via 5C and the heater electrode 3. A change of the voltage drop in the left-side tapered portion 3C from the left-side connection portion 3A2 to the main body 3B and a change of the voltage drop in the right-side tapered portion 3C from the main body 3B to the right-side connection portion 3A2 slow down, so that it is possible to prevent electric current from being concentrated between the connection portions 3A2 and the main body 3B in the heater electrode 3.

In the phase shifter 1C of the fourth embodiment, the electrodes 4 and the heater electrode 3 are connected to each other by the rectangular vias 5C. In the phase shifter 1C, it is possible to reduce the sizes of the rectangular via 5C, and it is possible to reduce the sizes of the electrodes 4 that are connected to the rectangular vias 5C and the sizes of the connection portions 3A2 of the heater electrode 3 that are connected to the rectangular vias 5C. As a result, it is possible to reduce the size of the phase shifter 1C. Furthermore, the sizes of the rectangular vias 5C are reduced and the widths of the heater electrode 3 and the electrodes 4 are reduced, so that it is possible to reduce heat conduction from the heater electrode 3 in which temperature increases to the electrodes 4.

Meanwhile, in the phase shifter 1A of the second embodiment, the example has been described in which the recessed portions 5A1 having the mortar shapes are formed in the via end portions of one sides of the single rectangular vias 5A, and the connection portions 3A of the heater electrode 3 and the electrodes 4 are electrically connected to each other by the single vias 5A. However, with use of the single vias 5A, it is difficult to ensure the reliability because of a disconnection or the like of the vias 5A. Therefore, an embodiment of a phase shifter that includes a plurality of vias will be described below as a fifth embodiment.

### (e) Fifth Embodiment

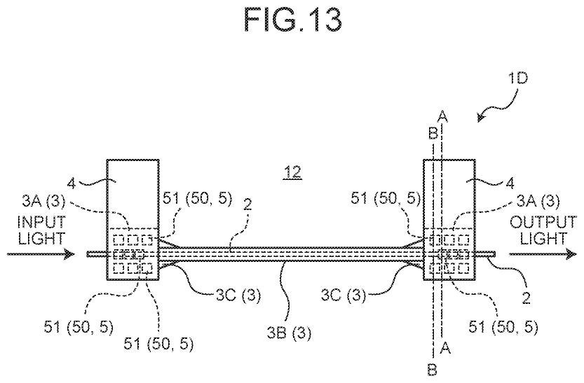

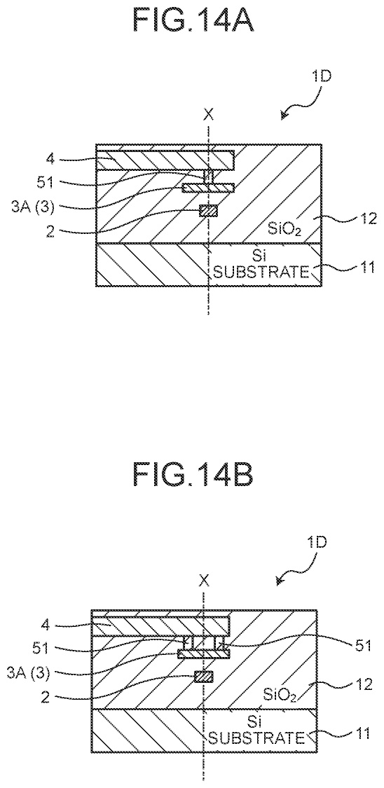

FIG. 13 is a schematic plan view illustrating one example of a phase shifter 1D of the fifth embodiment, FIG. 14A is a schematic cross-sectional view taken along a line A-A illustrated in FIG. 13, and FIG. 14B is a schematic cross-sectional view taken along a line B-B illustrated in FIG. 13. Meanwhile, the same components as those of the phase shifter 1A of the second embodiment will be denoted by the same reference symbols, and explanation of the same components and the same operation will be omitted.

The phase shifter 1D of the fifth embodiment is different from the phase shifter 1A of the second embodiment in that via groups 50 that includes a plurality of small vias 51 is provided instead of the single vias 5A that connect the connection portions 3A of the heater electrode 3 and the electrodes 4 to each other.

Each of the via groups 50 includes a plurality of, for example, the six rectangular small vias 51. Further, at least the three rectangular small vias 51 in the via group 50 are arranged on the center line X of the optical waveguide 2. Each of the rectangular small vias 51 electrically connects the connection portions 3A of the heater electrode 3 and the electrodes 4. The electrodes 4 and the heater electrode 3 are connected to each other by the plurality of rectangular small vias 51, and the rectangular small vias 51 that are located closer to the center line X of the optical waveguide 2 among the plurality of rectangular small vias 51 are arranged so as to be located away from the sides at which the heater electrode 3 is thinned. As a result, it is possible to equalize a distribution of electric current that flows into the plurality of rectangular small vias 51.

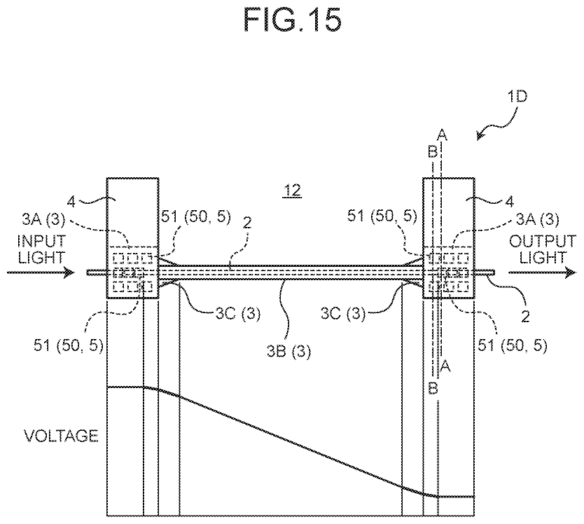

FIG. 15 is a diagram for explaining one example of a voltage change with respect to the heater electrode 3 of the phase shifter 1D of the fifth embodiment. Meanwhile, for convenience of explanation, it is assumed that electric current flows from the electrode 4 on the left side in the drawing to the electrode 4 on the right side in the drawing via the heater electrode 3. The conductivity of the heater electrode 3 is smaller than conductivity of the via groups 50, so that voltage of the heater electrode 3 that comes into contact with the left-side via group 50 and the right-side via group 50 is stable. A voltage drop starts from the connection portion 3A of the heater electrode 3 that is located in the small via 51 of the left-side via group 50, but a change of the voltage drop is slow. Further, a change of the voltage drop slows down in the left-side tapered portion 3C from the left-side connection portion 3A to the main body 3B. Furthermore, the voltage gradually decreases from the main body 3B of the heater electrode 3 to the connection portion 3A that is located in the small via 51 of the right-side via group 50. Moreover, a change of the voltage drop slows down in the right-side tapered portion 3C from the main body 3B to the right-side connection portion 3A. Furthermore, a change of the voltage drop slows down from the connection portion 3A of the heater electrode 3 that is located in the right-side small via 51, and then the voltage drop is stopped.

In other words, in the connection portion 3A of the heater electrode 3 that is located in the small via 51 of the left-side via group 50 (the small via 51 of the right-side via group 50), a change of the voltage drop slows down, so that it is possible to prevent a situation in which electric current is concentrated at the boundary between the small via 51 and the heater electrode 3. Furthermore, a change of the voltage drop in the left-side tapered portion 3C from the left-side connection portion 3A to the main body 3B and a change of the voltage drop in the right-side tapered portion 3C from the main body 3B to the right-side connection portion 3A slow down, so that it is possible to prevent electric current from being concentrated between the connection portions 3A and the main body 3B in the heater electrode 3.

In the phase shifter 1D of the fifth embodiment, the small vias 51 that are located closer to the center line X of the optical waveguide 2 among the plurality of small vias 51 in the via groups 50 are arranged so as to be located away from the main body 3B of the heater electrode 3. As a result, even if the single small via 51 is disconnected, the other small vias 51 are present, so that it is possible to ensure the reliability. In addition, electric current flows through each of the small vias 51, so that it is possible to equalize a distribution of the electric current and prevent the electric current from being concentrated.

Meanwhile, the example has been described in which the via groups 50 in the phase shifter 1D of the fifth embodiment include the plurality of rectangular small vias 51, but embodiments are not limited to this example, and another embodiment will be described below as a sixth embodiment.

### (f) Sixth Embodiment

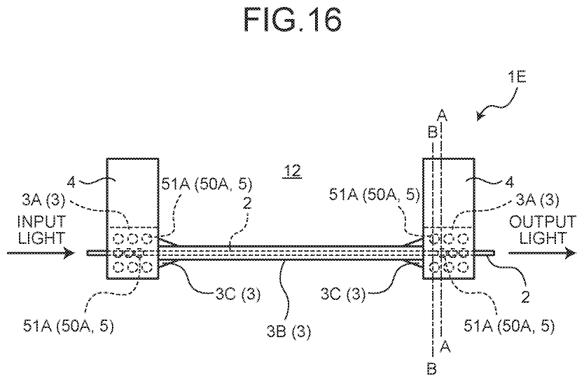

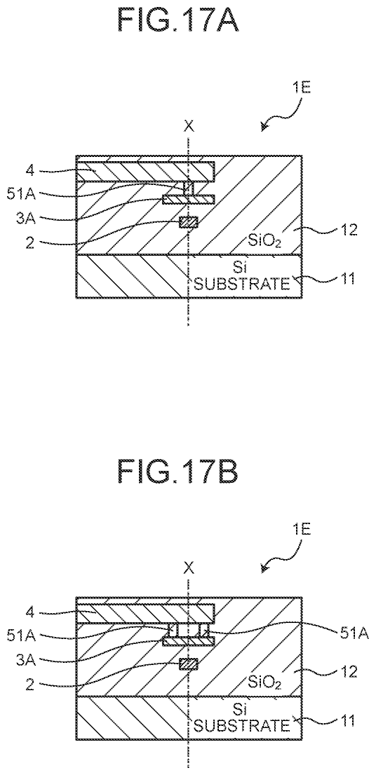

FIG. 16 is a schematic plan view illustrating one example of a phase shifter 1E of the sixth embodiment, FIG. 17A is a schematic cross-sectional view taken along a line A-A illustrated in FIG. 16, and FIG. 17B is a schematic cross-sectional view taken along a line B-B illustrated in FIG. 16. Meanwhile, the same components as those of the phase shifter 1D of the fifth embodiment will be denoted by the same reference symbols, and explanation of the same components and the same operation will be omitted.

The phase shifter 1E of the sixth embodiment is different from the phase shifter 1A of the second embodiment in that via groups 50A that include a plurality of circular small vias 51 are provided instead of the via groups 50 that include the plurality of rectangular small vias 51 for connection between the connection portions 3A of the heater electrode 3 and the electrodes 4.

Each of the via groups 50A includes a plurality of, for example, the six circular small vias 51A. Further, in the via groups 50A, at least the three circular small vias 51A are arranged on the center line X of the optical waveguide 2. Each of the circular small vias 51A electrically connects the connection portions 3A of the heater electrode 3 and the electrodes 4. The electrodes 4 and the heater electrode 3 are connected to each other by the plurality of circular small vias 51A, and the circular small vias 51A that are located closer to the center line X of the optical waveguide 2 among the plurality of circular small vias 51A are arranged so as to be located away from the sides at which the heater electrode 3 is thinned. As a result, it is possible to equalize a distribution of electric current that flows through the plurality of circular small vias 51A. In the rectangular small vias 51 of the fifth embodiment, the electric current is concentrated in corners of the rectangular small vias 51, but the circular small vias 51A are able to avoid a situation in which the electric current is concentrated.

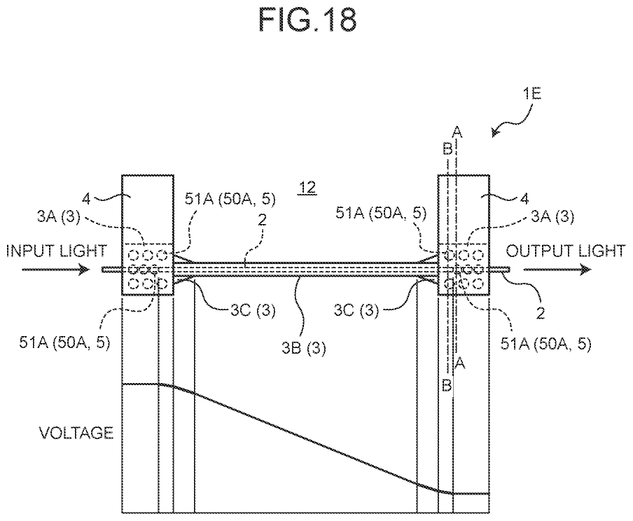

FIG. 18 is a diagram for explaining one example of a voltage change with respect to the heater electrode of the phase shifter 1E of the sixth embodiment. Meanwhile, for convenience of explanation, it is assumed that electric current flows from the electrode 4 on the left side in the drawing to the electrode 4 on the right side in the drawing via the heater electrode 3. The conductivity of the heater electrode 3 is smaller than conductivity of the via groups 50A, so that voltage of the heater electrode 3 that comes into contact with the left-side via group 50A and the right-side via group 50A is stable. A voltage drop starts from the connection portion 3A of the heater electrode 3 that is located in the small via 51A of the left-side via group 50A, but a change of the voltage drop is slow. Further, a change of the voltage drop slows down in the left-side tapered portion 3C from the left-side connection portion 3A to the main body 3B. Furthermore, the voltage gradually decreases from the main body 3B of the heater electrode 3 to the connection portion 3A that is located in the small via 51A of the right-side via group 50A. Moreover, a change of the voltage drop slows down in the right-side tapered portion 3C from the main body 3B to the right-side connection portion 3A. Furthermore, a change of the voltage drop slows down from the connection portion 3A of the heater electrode 3 that is located on the right-side small via 51A, and the voltage drop is stopped.

In other words, in the connection portion 3A of the heater electrode 3 that is located in the small via 51A of the left-side via group 50A (the small via 51A of the right-side via group 50A), a change of the voltage drop slows down, so that it is possible to prevent a situation in which electric current is concentrated at the boundary between the small via 51A and the heater electrode 3. Furthermore, a change of the voltage drop in the left-side tapered portion 3C between the left-side connection portion 3A and the main body 3B and a change of the voltage drop in the right-side tapered portion 3C from the main body 3B to the right-side connection portion 3A slow down, so that it is possible to prevent electric current from being concentrated between the connection portion 3A and the main body 3B in the heater electrode 3.

In the phase shifter 1E of the sixth embodiment, the circular small vias 51A that are located closer to the center line X of the optical waveguide 2 among the plurality of circular small vias 51A in the via groups 50A are arranged so as to be located away from the main body 3B of the heater electrode 3. As a result, even if the single small via 51A is disconnected, the other small vias 51A are present, so that it is possible to ensure the reliability. In addition, electric current flows through each of the small vias 51A, so that it is possible to equalize a distribution of the electric current and prevent the electric current from being concentrated.

Meanwhile, for convenience of explanation, the example has been described in which the optical waveguide 2 is a channel waveguide, but embodiments are not limited to the channel waveguide, but may be, for example, a rib waveguide or the like, and an appropriate change is applicable.

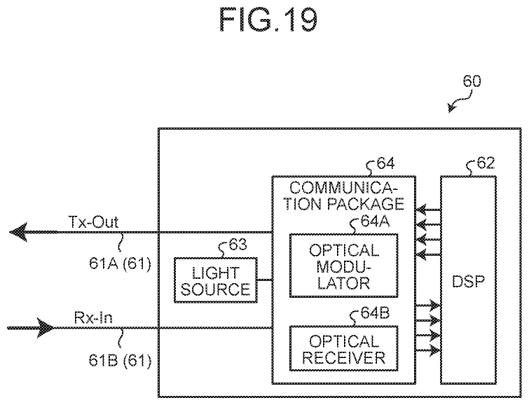

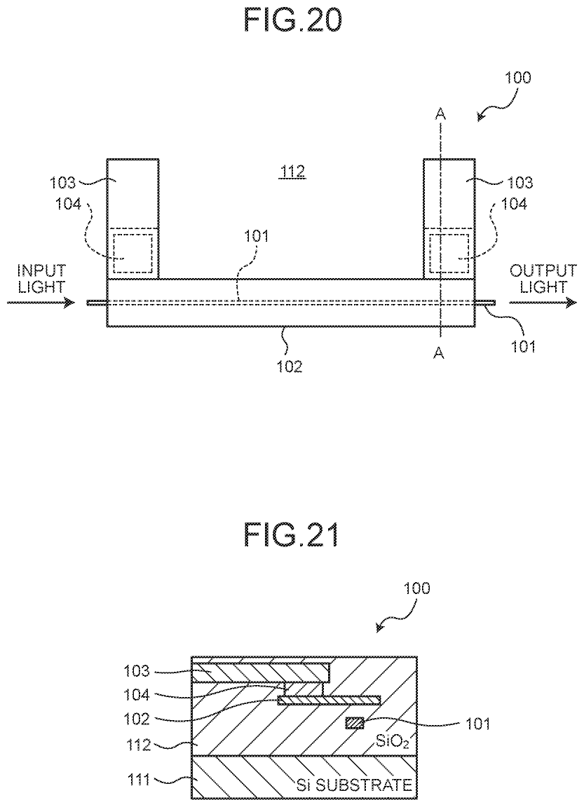

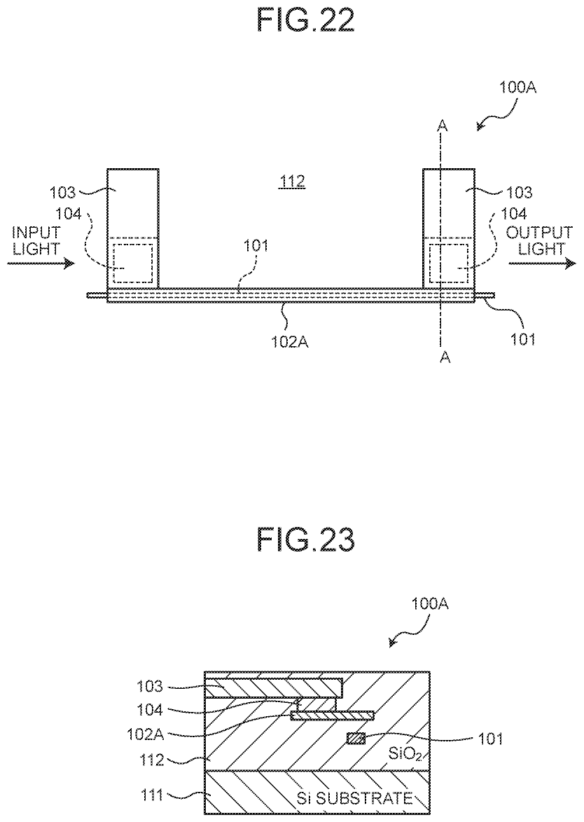

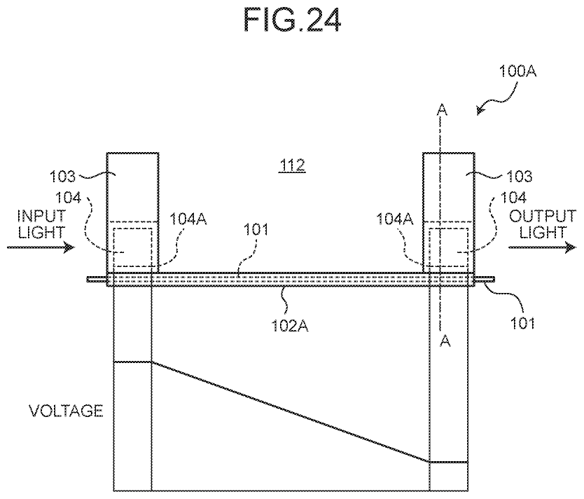

FIG. 19 is a diagram for explaining one example of an optical communication apparatus 60 according to the present embodiment. The optical communication apparatus 60 illustrated in FIG. 19 is connected to an output-side optical fiber 61A (61) and an input-side optical fiber 61B (61). The optical communication apparatus 60 includes a Digital Signal Processor (DSP) 62, a light source 63, and a communication package 64. The DSP 62 is an electric component that performs digital signal processing. The communication package 64 includes an optical modulator 64A and an optical receiver 64B. The DSP 62 performs a process, such as encoding, on transmission data, generates an electric signal including the transmission data, and outputs the generated electric signal to the optical modulator 64A, for example. Further, the DSP 62 acquires an electric signal including reception data from the optical receiver 64B, performs a process, such as decoding, on the acquired electric signal, and obtains reception data.

The light source 63 includes, for example, a laser diode or the like, generates light with a predetermined wavelength, and supplies the light to the optical modulator 64A and the optical receiver 64B. The optical modulator 64A is an optical device that modulates the light supplied from the light source 63 by using the electric signal output from the DSP 62, and outputs the obtained optical transmission signal to the optical fiber 61A. The optical modulator 64A is an optical modulator or the like that includes the phase shifter 1 or the like. The optical modulator 64A, when the light supplied from the light source 63 propagates through the waveguide, modulates the light in accordance with the electric signal and generates transmission light. The phase shifter 1 shifts a phase of signal light that passes through the optical waveguide 2.

The optical receiver 64B receives an optical signal from the optical fiber 61B, and demodulates the received light by using the light supplied from the light source 63. Further, the optical receiver 64B converts the demodulated received light to an electric signal, and outputs the converted electric signal to the DSP 62. Meanwhile, the optical receiver 64B also includes the phase shifter 1 or the like.

The optical communication apparatus 60 is configured such that the optical modulator 64A and the optical receiver 64B are integrated into a single chip, so that it is possible to contribute to reduce the entire size of the optical communication apparatus 60.

While the example has been described in which the optical communication apparatus 60 includes, inside thereof, the optical modulator 64A and the optical receiver 64B, but the optical communication apparatus 60 that includes only any one of the optical modulator 64A and the optical receiver 64B inside thereof is applicable, and an appropriate change is applicable.

According to one aspect, it is possible to reduce power consumption and ensure long-term reliability of a heater electrode.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a heater electrode that heats an optical waveguide;
an electrode that has larger conductivity than conductivity of the heater electrode; and
a via that electrically connects the heater electrode and the electrode, wherein
the heater electrode includes
a connection portion that is connected to the via and that has a large electrode width; and
a main body that has a thinner electrode width than the electrode width of the connection portion, and
the via is located on a center line of the heater electrode and includes a via end portion at a side of the main body, the via end portion being configured to diffuse electric current that flows between the via and the heater electrode.

2. The optical device according to claim 1, wherein the via has a recessed portion in which the via end portion at the side of the main body is recessed.

3. The optical device according to claim 1, wherein the via is made of a same material as the electrode.

4. The optical device according to claim 1, wherein the heater electrode includes a tapered portion that is formed between the connection portion and the main body such that an electrode width is gradually reduced from the connection portion to the main body.

5. The optical device according to claim 2, wherein the via is formed as a recessed portion that has a mortar planar shape in which the via end portion at the side of the main body is recessed.

6. The optical device according to claim 1, wherein the via is formed as a recessed portion that has an arc planar shape in which the via end portion at the side of the main body is recessed.

7. The optical device according to claim 1, wherein the via is formed as a via that has a linear planar shape in which the via end portion at the side of the main body is recessed.

8. The optical device according to claim 7, wherein the via is formed as a via that has a rectangular planar shape that includes a first side parallel to the optical waveguide and a second side perpendicular to the optical waveguide, the first side having a first dimension that is shorter than a second dimension of the second side.

9. The optical device according to claim 1, wherein
the via includes a plurality of small vias that electrically connect the electrode and the heater electrode, and
a part of the small vias is located on the center line of the heater electrode and arranged so as to be located away from the main body.

10. The optical device according to claim 9, wherein the small vias are vias that have rectangular planar shapes.

11. The optical device according to claim 9, wherein the small vias are vias that have circular planar shapes.

12. An optical transmission apparatus comprising:
a processor that performs signal processing on an electric signal;
a light source that emits light; and
an optical modulator that modulates the light emitted from the light source by using the electric signal output from the processor, wherein
a phase shifter in the optical modulator includes:
a heater electrode that heats an optical waveguide;
an electrode that has larger conductivity than conductivity of the heater electrode; and
a via that electrically connects the heater electrode and the electrode, and
the heater electrode includes
a connection portion that is connected to the via and that has a large electrode width; and
a main body that has a thinner electrode width than the electrode width of the connection portion, and
the via is located on a center line of the heater electrode and includes a via end portion at a side of the main body, the via end portion being configured to diffuse electric current that flows between the via and the heater electrode.

13. An optical reception apparatus comprising:
a light source that emits light; and
an optical receiver that demodulates received light by using the light from the light source, wherein
a phase shifter in the optical receiver includes:
a heater electrode that heats an optical waveguide;
an electrode that has larger conductivity than conductivity of the heater electrode; and
a via that electrically connects the heater electrode and the electrode, and
the heater electrode includes
a connection portion that is connected to the via and that has a large electrode width; and
a main body that has a thinner electrode width than the electrode width of the connection portion, and
the via is located on a center line of the heater electrode and includes a via end portion at a side of the main body, the via end portion being configured to diffuse electric current that flows between the via and the heater electrode.
